(19) United States
(12) Patent Application Publication
(10) Pub. No.: US 2022/0389658 A1
(43) Pub. Date: Dec. 8, 2022

(54) MFC SUBSTRATE WITH ENHANCED WATER VAPOUR BARRIER

(71) Applicant: Stora Enso OYJ, Helsinki (FI)

(72) Inventors: Isto Heiskanen, Imatra (FI); Katja Lyytikäinen, Imatra (FI); Otto Nylén, Helsinki (FI); Kaj Backfolk, Lappeenranta (FI)

(73) Assignee: Stora Enso OYJ, Helsinki (FI)

(21) Appl. No.: 17/755,338

(22) PCT Filed: Nov. 4, 2020
(86) PCT No.: PCT/IB2020/060349

§ 371 Date: Apr. 27, 2022

(30) Foreign Application Priority Data
Nov. 4, 2019 (SE) 1951259-9

(51) Int. Cl. D21H 11/18; D21H 21/16; D21H 19/12; D21H 19/82; D21H 17/14

(52) U.S. Cl. CPC D21H 11/18; D21H 21/16; D21H 19/12; D21H 19/824; D21H 17/14

(57) ABSTRACT

A barrier material comprising (a) at least one layer of cellulosic substrate comprising MFC, and (b) a first barrier layer arranged on at least one surface of said cellulosic substrate, is provided, as well as a method for reducing the water vapour transmission rate (WVTR) of a cellulosic substrate.

### TECHNICAL FIELD

A barrier material comprising (a) at least one layer of cellulosic substrate comprising microfibrillated cellulose, and (b) a first barrier layer arranged on at least one surface of said cellulosic substrate, is provided, as well as a method for reducing the water vapour transmission rate (WVTR) of a cellulosic substrate, and optionally improve the oxygen barrier (OTR) and/or the barrier to oil and/or grease of the cellulosic substrate.

### BACKGROUND

One problem with cellulose-based substrates is that they are very sensitive to moisture and provide substantially no oxygen barrier at high relative humidity (RH) and little or no moisture barrier at low or high RH. Another problem is that cellulose films are very difficult to produce with a wet laid technique using a wire such as on a paper machine since fast dewatering is difficult and impacts the web quality and particularly the subsequent barrier properties.

The problem of moisture sensitivity of nanocellulosic material, such as microfibrillated cellulose materials is described in many scientific articles including a number of theories and effects of the water vapor-induced swelling and such as good oxygen barrier, see review e.g. by Wang, J., et al., (Moisture and Oxygen Barrier Properties of Cellulose Nanomaterial-Based Films, ACS Sustainable Chem. Eng., 2018, 6 (1), pp 49-70). In addition to the role of cellulose crystallinity and polymer additives (Kontturi, K., Kontturi, E., Laine, J., Specific water uptake of thin films from nanofibrillar cellulose, Journal of Materials Chemistry A, 2013, 1, 13655), a number of various hydrophobic coating solutions have been suggested.

These problems apply not only for neat substrates but also for converted substrates (i.e. those in which the substrate is e.g. laminated with other substrates such as paper or paperboards, which also lack a moisture barrier, as moisture diffusion will cause reduced barrier properties with time).

One challenge is to create a thin substrate with many barrier properties without using plastic layer(s) such as PE, or to be able to reduce the plastic layer(s) or the thickness of the applied plastic layer(s). The present technology allows the creation of a sustainable substrate or film having enhanced barrier properties (for oxygen, water vapor and other gases) without using a plastic laminate or coating. This substrate can be laminated with polymer or plastic layer to achieve super barrier properties or to provide other features such as heat sealability or liquid barrier.

### SUMMARY

A method for reducing the water vapour transmission rate (WVTR) of a cellulosic substrate comprising microfibrillated cellulose (MFC) is provided, said method comprising the steps of:
a. providing a cellulosic substrate comprising MFC;
b. applying a first surface treatment composition to at least one surface of said cellulosic substrate, said first surface treatment composition comprising a water-soluble polymer and a crosslinker; and
c. allowing said first surface treatment composition to cure to form a first barrier layer on said at least one surface of said cellulosic substrate.

Also provided is a barrier material comprising:
at least one layer of cellulosic substrate comprising MFC,
a first barrier layer arranged on at least one surface of said cellulosic substrate, said first barrier layer being formed by applying a first surface treatment composition comprising a water-soluble polymer and a crosslinker to said cellulosic substrate and allowing said first surface treatment composition to cure, thus forming a first barrier layer.

Additional aspects of the invention are set out in the following detailed description, the examples and the appended claims.

### DETAILED DISCLOSURE OF THE INVENTION

It has been found that a significant improvement in water vapour barrier properties of a MFC substrate can be achieved by
a. providing a cellulosic substrate comprising MFC;
b. applying a first surface treatment composition to at least one surface of said cellulosic substrate, said first surface treatment composition comprising a water-soluble polymer and a crosslinker; and
c. allowing said first surface treatment composition to cure to form a first barrier layer on said at least one surface of said cellulosic substrate.

Disclosed herein is thus a method for reducing the water vapour transmission rate (WVTR) of a cellulosic substrate comprising MFC, said method comprising the steps of:

a. providing a cellulosic substrate comprising MFC;

b. applying a first surface treatment composition to at least one surface of said cellulosic substrate, said first surface treatment composition comprising a water-soluble polymer and a crosslinker; and

c. allowing said first surface treatment composition to cure to form a first barrier layer on said at least one surface of said cellulosic substrate.

A barrier material—which may be produced according to the method described herein comprises:
at least one layer of cellulosic substrate comprising MFC,
a first barrier layer arranged on at least one surface of said cellulosic substrate, said first barrier layer being formed by applying a first surface treatment composition comprising a water-soluble polymer and a crosslinker to said cellulosic substrate and allowing said first surface treatment composition to cure, thus forming a first barrier layer.

Without being bound by theory it is believed that the improved properties of the barrier material disclosed herein is that one layer provides a good oxygen barrier (in this case the substrate of MFC) and one barrier layer provides good WVTR (cross-linked layer) and where the applied coating with crosslinker is able to provide complementary physical and mechanical properties to the base substrate.

In an embodiment, the barrier layer may be in form of one, two or more barrier layer(s) and arranged on either one or both sides of a substrate. In an embodiment, a first barrier layer is arranged on only one surface of a substrate or on both sides of a substrate. In an embodiment, a first and a second barrier layer are arranged on only one surface of a substrate or on both sides of a substrate.

Preferably, the barrier material disclosed herein improves at least two barrier properties simultaneously, e.g. improved WVTR, improved OTR, resistance to oil and/or grease. In an embodiment, the coating will primarily give good water vapour barrier, but it will also assist in improving the OTR for the substrate. In an embodiment, the barrier material will provide good resistance against food derived oil and/or grease.

In another embodiment, the barrier material is used for packaging or wrapping applications such as industrial, food, cosmetic and personal care or electronics applications. The barrier material can also be used for packaging papers including greaseproof papers, or as base sheets e.g for straws.

Details of the method and the barrier material of the invention are described below. Details of the method of the invention can be applied to the barrier material of the invention and vice versa, mutatis mutandis.

Cellulosic Substrate Comprising MFC

The present technology requires a cellulosic substrate comprising microfibrillated cellulose (MFC).

There are different synonyms for MFC such as cellulose microfibrils, fibrillated cellulose, nanocellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. The cellulose fiber is preferably fibrillated to such an extent that the final specific surface area of the formed nanocellulose is from about 1 to about 400 m²/g, such as from 10 to 300 m²/g or more preferably 50-200 m²/g when determined for a solvent exchanged and freeze-dried material with the BET method. The mean average fibril diameter of the MFC is 1-1000 nm, preferably 10-1000 nm. In an embodiment, the MFC comprises at least 50 wt %, such as at least 60 wt %, suitably at least 70 wt % of fibrils having a mean average fibril diameter less than 100 nm. The MFC may be characterised by analysing high resolution SEM or ESEM images.

Various methods exist to make microfibrillated cellulose, such as single or multiple pass refining, pre-hydrolysis followed by refining or high shear disintegration or liberation of fibrils. One or several pre-treatment steps are usually required in order to make microfibrillated cellulose manufacturing both energy-efficient and sustainable. The cellulose fibers of the pulp to be supplied may thus be pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl, aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into microfibrillated cellulose.

The microfibrillated cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, single—or twin—screw extruder, fluidizer such as microfluidizer, macrofluidizer or other fluidizer-type homogenizer. Depending on the MFC manufacturing method, the product might also contain fines, or nanocrystalline cellulose or e.g. other chemical compounds present in wood fibers or in papermaking process. The product might also contain various amounts of micron-sized fiber particles that have not been efficiently fibrillated.

MFC can be produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper, i.e. pre- and post-consumer waste.

The MFC can be native (i.e. chemically unmodified), or it can be chemically modified.

Phosphorylated nanocellulose (also called phosphorylated microfibrillated cellulose; P-MFC) is typically obtained by reacting cellulose fibers soaked in a solution of NH₄H₂PO₄, water and urea and subsequently fibrillating the fibers to P-MFC. One particular method involves providing a suspension of cellulose pulp fibers in water and phosphorylating the cellulose pulp fibers in said water suspension with a phosphorylating agent, followed by fibrillation with methods common in the art. Suitable phosphorylating agents include phosphoric acid, phosphorus pentaoxide, phosphorus oxychloride, diammonium hydrogen phosphate and sodium dihydrogen phosphate.

A suspension of microfibrillated cellulose is used to form the cellulosic substrate. Typically, the cellulosic substrate comprises microfibrillated cellulose in an amount of between 0.01-100 wt % based on total solid content, such as between 30 and 100 wt %, suitably between 40 and 100 wt %, such as between 50 and 100 wt %, or between 70 and 100 wt %.

The suspension used to form the cellulosic substrate is typically an aqueous suspension. The suspension may comprise additional chemical components known from papermaking processes. Examples of these may be nanofillers or fillers such as nanoclays, bentonite, talc, calcium carbonate, kaolin, SiO₂, Al₂O₃, TiO2, gypsum, etc. The fibrous substrate may also contain strengthening agents such as cellulose derivatives or native starch or modified starch such as, for example, cationic starch, nonionic starch, anionic starch or amphoteric starch. The strengthening agent can also be synthetic polymers. In a further embodiment, the fibrous substrate may also contain retention and drainage chemicals such as cationic polyacrylamide, anionic polyacrylamide, silica, nanoclays, alum, P-DADMAC, PEI, PVAm, etc. In yet a further embodiment, the cellulosic substrate may also contain other typical process or performance chemicals such as dyes or fluorescent whitening agents, defoamers, wet strength resins, biocides, hydrophobic agents, barrier chemicals etc.

The microfibrillated cellulose suspension may additionally comprise cationic or anionic microfibrillated cellulose; such as carboxymethylated microfibrillated cellulose. In an embodiment, the cationic or anionic microfibrillated cellulose is present in an amount of less than 50 wt % of the total amount of microfibrillated cellulose, preferably in an amount of less than 40 wt %, or more preferably in an amount of less than 30 wt %.

The forming process of the cellulosic substrate from the suspension may be casting or wet-laying to create a free-standing film or coating on a substrate from which the cellulosic substrate is not removed. The cellulosic substrate formed in the present methods should be understood as having two opposing primary surfaces. Accordingly, the cellulosic substrate may be a film or a coating, and is most preferably a film. The cellulosic substrate may have a grammage of between 1-80, preferably between 10-50 gsm, such as e.g. 10-40 gsm, most preferably between 20-35 gsm. For coatings in particular, the grammage can be low, e.g. 0.1-20 gsm or more preferably even 0.1-10 gsm.

In one aspect of the methods described herein, the cellulosic substrate is surface-treated after it has been dried, e.g. while it has a solid content of 40-99.5% by weight, such as e.g. 60-99% by weight, 80-99% by weight or 90-99% by weight.

In one aspect of the methods described herein, the cellulosic substrate to be surface-treated has been formed by wet-laying, preferably on a porous wire on a paper or paperboard machine and has a solid content of 50-99% by weight.

In another aspect of the methods described herein, the cellulosic substrate to be surface-treated has been formed by casting and has a solid content of 50-99% by weight.

In another aspect of the methods described herein, the cellulosic substrate is surface-treated after it has been dried, e.g. while it has a solid content of 50-99% by weight, such as e.g. 60-99% by weight, 80-99% by weight or 90-99% by weight.

In another aspect of the methods described herein, the cellulosic substrate is surface-treated before it has been dried, e.g. while it has a solid content of 0.1-50% by weight, such as e.g. 1-40% by weight or 10-30% by weight.

In another aspect of the methods described herein, the cellulosic substrate to be surface-treated is a free-standing film having a grammage in the range of 1-100 g/m² after treatment, more preferred in the range of 10-50 g/m² after treatment. This free-standing film may be directly attached onto a carrier substrate or attached via one or more tie layers.

In an embodiment, the carrier substrate is paper or paperboard or plastic or mineral coated paper or paperboard. Examples of substrates are e.g. greaseproof papers, glassine papers, parchment papers, label papers, bag and sack kraft papers, impregnated papers, solid bleached board, solid unbleached board, folding boxboard, white lined chipboard, corrugated board.

The herein disclosed barrier material can thus be applied on said substrates in an off line or on-line process. Preferably, the herein disclosed barrier material might be further laminated and produced to the desired end product.

The amount of pulp fibers and coarse fines can be in the range of 0-60 wt %. The amount of pulp fibers and fines may be estimated afterwards e.g. by disintegrating a dry or wet sample, followed by fractionation and analysis of particle sizes of the fractions. Preferably, a never-dried furnish is fractionated and analysed in order to determine the amount of fines and fibers, respectively.

The cellulosic substrate may also comprise one or more fillers, such as a nanofiller, in the range of 1-50% by weight. Typical nanofillers can be nanoclays, bentonite, silica or silicates, calcium carbonate, talcum, etc. Preferably, at least one part of the filler is a platy filler. Preferably, one dimension of the filler should have an average thickness or length of 1 nm to 10 μm. If determining the particle size distribution of fillers for example with light scattering techniques, the preferred particle size should be that more than 90% is below 2 μm.

The surface-treated cellulosic substrate preferably has a surface-pH of 3-12 or more preferred a surface-pH of 5.5-11. More specifically, the surface-treated cellulosic substrate may have a surface-pH higher than 3, preferably higher than 5.5. In particular, the surface-treated cellulosic substrate may have a surface-pH less than 12, preferably less than 11.

The pH of the surface of the cellulosic substrate is measured on the final product, i.e. the dry product. “Surface pH” is measured by using fresh pure water which is placed on the surface. Five parallel measurements are performed and the average pH value is calculated. The sensor is flushed with pure or ultra-pure water and the paper sample is then placed on the moist/wet sensor surface and pH is recorded after 30 s. Standard pH meters are used for the measurement.

Before surface treatment, the cellulosic substrate suitably has an Oxygen Transmission Rate (OTR) value in the range 100-5000 cc/m²/24 h (38° C., 85% RH) according to ASTM D-3985 at a grammage between 10-50 gsm, more preferably in the range of 100-1000 cc/m²/24 h.

The grammage of the cellulosic substrate is preferably 10-50 gsm. Typically, such substrates have basically no or very low water vapour barrier. The substrate may therefore have a WVTR (at 23° C. and 50% RH) prior to application of said first surface treatment composition of greater than 100 g/m2/d, preferably greater than 200 g/m2/d and more preferably greater than 500 g/m2/d.

The substrate may be translucent or transparent. In an embodiment, the cellulosic substrate has a translucency of at least 75%, preferably at least 80%, measured according to DIN 53147. The MFC substrate can also be a MFC coating or film on e.g. paperboard. The profile of the substrate is controlled by e.g. even moisture profile or by supercalendering or by re-moisturizing and re-drying. The method disclosed herein may therefore further comprise a step of calendaring the cellulosic substrate prior to applying said first surface treatment composition.

First Surface Treatment Composition

A first surface treatment composition is applied to at least one surface of the cellulosic substrate. The first surface treatment composition comprises a water-soluble polymer and a crosslinker.

A first barrier layer is thus formed by applying the first surface treatment composition to said cellulosic substrate and allowing said first surface treatment composition to cure. The first surface treatment composition is typically applied in a coat weight of 1-10 gsm, preferably 1-4 gsm.

The extent of curing may be determined by different means but the effect of curing is usually seen as improved barrier properties. The extent of curing may also be possible to detect e.g. as the formation of new types of bonds by using spectroscopic methods.

In an embodiment, a crosslinker is chosen which is capable of crosslinking the first surface treatment composition which thus changes its physico-chemical properties compared to a corresponding surface treatment made without a cross-linker. The ratio of cross-linker and polymer is preferably between 5:95 and 95:5 and more preferably between 10:90 and 90:10 and more preferably between 20:80 and 80:20 and most preferably between 30:70 and 70:30 (w/w).

It is preferred that the crosslinker is also able to crosslink MFC, and to crosslink between the water-soluble polymer and MFC, thereby increasing the integrity of the substrate. Therefore, the crosslinker crosslinks particularly the barrier layer, but also cross-links the barrier layer with the substrate and even to some extent within the substrate itself.

The crosslinker is suitably selected from an organic acid, preferably an organic polyacid; and a metal salt of an organic acid or organic polyacid; or mixtures of an organic acid and a metal salt of an organic acid. An “organic acid” is an organic molecule comprising a carboxylic acid moiety (—CO₂H), while an “organic polyacid” is an organic molecule comprising more than one of such carboxylic acid moieties. Suitable organic acids are selected from citric acid, lactic acid, acetic acid, formic acid, oxalic acid, uric acid, malic acid, 1,2,3,4-butanetetracarboxylic acid, malonic acid or tartaric acid. Citric acid is most preferred. The amount of citric acid can vary between 5:95 to 95:5 (w/w) but the ratio can vary depending on the polymer, the coating method and the applied layers.

Suitable metal salts of the organic acids or polyacids are sodium, potassium, magnesium or calcium salts, sodium salts being most preferred, such as sodium citrate. By including metal salts of the organic acids or polyacids, a buffered aqueous solution can be provided in which the crosslinker comprises an organic acid, preferably an organic polyacid, and a metal salt of said organic acid. In an embodiment, a particular buffer solution is made so that the ready mix has a higher pH value. Preferred pH ranges for the buffered solutions are e.g. 4-6 or 5-7 or 6-8 or 7-9 or 8-10 or 9-11.

The total solids content of the first surface treatment composition is more than 10% w/w, and preferably more than 15% w/w.

Typically, the first surface treatment composition comprises at least 2%, such as at least 5%, such as at least 10% w/w water-soluble polymer. The water-soluble polymer is selected from polyvinyl alcohol, polyacrylate, polysaccharides such as e.g. starch, cellulose or guar gum; or mixtures or co-polymers thereof and is preferably polyvinyl alcohol. An example could be a mixture of polyvinyl alcohol and polysaccharides.

The term “polyvinyl alcohol” includes partly or fully hydrolysed, ethylated, cationized or carboxylated polyvinyl alcohol. The term “starch” includes modified starch, such as anionic, cationic, non-ionic or hydrophobically modified starch. The term “cellulose” includes cellulose derivatives including hemicellulose, suitably sodium carboxymethyl cellulose (NaCMC), hydroxyethylcellulose (HEC) and ethyl hydroxyethylcellulose (EHEC).

Notably, solutions of water-soluble polymers (e.g. polyvinyl alcohol) are normally not used for moisture barriers, as they are themselves susceptible to being dissolved in water or moisture.

In an embodiment, the cellulosic substrate and one first barrier layer may be provided having a grammage of less than 60 gsm or more preferably less than 50 gsm and most pref. less than 40 gsm.

Steps b. and c. of the method may be repeated such that more than one, such as e.g. 2, 3, 4, 5 or 10 first barrier layers are applied. Accordingly, the barrier material may comprise more than one, such as e.g. 2, 3, 4, 5 or 10 first barrier layers.

It was surprising that no blistering occurred when applying the first surface treatment composition, since it is quite common that especially film forming polymers might cause skin formation and hence tendency to blistering.

Further Surface Treatment Compositions

In one aspect—after curing of the first surface treatment composition—a second surface treatment composition may be applied to the first barrier layer. The second surface treatment composition comprises a second water-soluble polymer and optionally a crosslinker. Allowing said second surface treatment composition to dry and/or cure forms a second barrier layer.

The second surface treatment composition and/or the primer surface treatment composition typically additionally comprise a metal salt.

In one alternative, the second surface treatment composition is devoid of crosslinker. In such cases, the water-soluble polymers do not crosslink/cure, but merely dry and form a film or coating.

Typically, the first and second surface treatment compositions are aqueous solutions of water-soluble polymer and—where applicable—said crosslinker.

In one preferred aspect, the first surface treatment composition and the second surface treatment composition comprise the same water-soluble polymer. This provides enhanced compatibility between the barrier layers thus formed. The term “same” when applied to the water-soluble polymer means that two such polymers are formed from the same monomer, although they may differ in other properties, such as molecular weight.

In a similar manner, the first surface treatment composition, the second surface treatment composition may comprise the same crosslinker. This may allow crosslinking between barrier layers, as well as internally within the same barrier layer.

The surface treatment composition(s), in particular the first surface treatment composition, typically have a pH between 3 and 7. This may be achieved by including a buffer in the composition, as described above.

Suitable methods for applying the surface treatment composition(s) including by means of a printing press such as a flexogravure, rotogravure, rotary or flatbed screen, reverse rotogravure, inkjet or offset printing press, Anilox type of applicator or modified versions thereof; or a film press, surface sizing, blade or rod coating, spray coating or curtain coating. The coating can be made either off-line or on-line.

Preferably, the coating is applied in at least one layer having a dry coat weight of 1-10 gsm, preferably 1-4 gsm.

Coating is preferably applied on at least one side and in at least one step. If using e.g. printing press to apply the surface treatment solution, the applied amounts are 2-80 gsm as wet or more pref. 3-40 gsm as wet (based on Anilox cell volume and 100% transfer efficiency) per printing station. The dry content of the liquid is preferably higher than 1 wt % or more pref.>5% and most pref.>10 wt %.

For ease of application, the surface treatment composition(s) may have a Brookfield viscosity between 100-10 000 mPas or more pref. 300-8000 mPas, and most pref. 500-3000 mPas, measured at 100 rpm and 23° C.

Calendering of the substrate can be done on-line or off-line using e.g. one or several calendering nips with high nip loads and temperature such as in supercalander. Also, smoothening with e.g. a Yankee cylinder can be utilized. Also, the calendaring can be done at higher temperatures to ensure curing and improved cross-linking. Temperatures such as T>120° C. or more preferably >140° C. or most preferably >160° C. but less than 240° C. (cylinder temperature) may be used. In this regard, calendaring refers to a post treatment which improves the crosslinking by applying extra heat and pressure. The examples show results from using both uncalendered and super calendered substrate, i.e. prior to surface treatment.

Material Properties

The MFC suspension used to make the cellulosic substrate—prior to being coated—has a Schopper-Riegler (SR) value according to ISO 5267-1 of greater than 50, preferably greater than 60 and more preferably greater than 70. The SR value is a measure of degree of refining of cellulosic fibres, and is a measure of the drainage resistance of the suspension. It must be understood, that the SR value can be determined accurately for only coarser MFC grades and certain fine microfibrillated cellulose-fiber mixes since higher content of very fine fibrils might pass through the wire and thus the actual solid content in the remaining suspension providing the dewatering resistance is reduced.

Prior to application of the surface treatment compositions the cellulosic substrate in an embodiment has an air resistance value according to ISO 5636-5 of less than 25 000 s/100 ml, preferably less than 20 000 s/100 ml and more preferably less than 15 000 s/100 ml. The present technology allows an increase in this air resistance value. Accordingly, after curing of the first surface treatment composition, the cellulosic substrate in one embodiment has an air resistance value according to ISO 5636-5 after curing of said first surface treatment composition of greater than 25 000 s/100 ml, preferably greater than 30 000 s/100 ml and more preferably greater than 40000 s/100 ml. In another embodiment, the air resistance is non-measurable, i.e. too high to measure using the ISO method 5636-5.

The present technology also allows improved water vapour barrier properties, measured as WVTR. Therefore, prior to application of the first surface treatment composition, the cellulosic substrate typically has a WVTR (at 23° C. and 50% RH) prior to of greater than 100 g/m²/d, preferably greater than 200 g/m²/d and more preferably greater than 500 g/m²/d.

After curing of the first surface treatment composition, the cellulosic substrate typically has a WVTR (at 23° C. and 50% RH) of less than 100 g/m²/d, preferably less than 75 g/m²/d and more preferably less than 50 g/m²/d.

After curing of the first surface treatment composition, the cellulosic substrate typically has a grease resistance (at 23° C. and 50% RH) after curing of said first surface treatment composition of more than 5 h, preferably more than 15 h, and more preferably more than 20 h according to the Modified ASTM F119-82 method.

### EXAMPLES

A web comprising 100% microfibrillated sheet was prepared using a wet laid method using a fourdrinier concept followed by a press section and a drying section. The substrate was prepared to a basis weight of 32 gsm and dried to a moisture content less than 10 wt %. The Microfibrillated Cellulose had a Schopper-Riegler value of 92. The said substrate was used both in uncalendered form and after being calendered using a supercalander.

Polyvinyl alcohol (Poval 15-99, Kuraray) was prepared by dissolving at high temperature for 1 hour under stirring. The solution was allowed to cool to room temperature before mixed with cross-linking agent (citric acid). The mixture of PVOH and citric acid was made in ratio of 50/50 and pH was adjusted to 4.4. The dry content of the mixture was 17 wt-%

The polymer solutions were applied with a flexogravure unit using one and two printing stations respectively. The Anilox cell volume was 15 cm³/m². Interim post-drying was made with IR dryers. The speed was 13 m/min. The estimated coat weight was about 0.3-1 g/m². Only one side of the substrate was treated and the treated side was analyzed.

The test methods used were:

Schopper-Riegler (SR) (ISO 5267-1)

Oxygen transmission rate (OTR) (ASTM F-1927),

Water Vapour Transmission rate (WVTR) (ASTM F-1249)

Grease resistance, Chicken fat, 60° C. (Modified ASTM F119-82)

### Example 1—Comparative Example

32 gsm substrate was prepared with an air resistance (Gurley-Hill) value of 2003 (s/100 ml). This sample had no gas barrier properties which is also indicated by the low G-H value.

### Example 2—Comparative Example

Same sample as in example 1 but the substrate was supercalendered. Small improvement especially in gloss but not in barrier properties.

### Example 3—Comparative Example

The sample 2 was laminated with polyethylene film (extrusion coating). The film has good water vapour barrier properties and also good oxygen barrier.

### Example 4

The web used in example 1 was surface treated with the PVOH solution free from cross-linker using one printing station. Gurley-Hill value was 644 s/100 ml (average of 3 measurements) indicating poor barrier properties.

### Example 5

The web used in example 2 was surface treated with one printing nip according to the description above. The PVOH was mixed with citric acid and pH was adjusted to 4. The G-H was 42300 s/100 ml and barrier tests were performed as shown in the table below. All barrier results were good.

### Example 6

The web used in example 2 was run through 2 printing nips with PVOH and citric acid mixture in the first nip and PVOH in the second nip. This combination gave very good barrier properties as shown in the table below.

| | | OTR | | OTR | | WVTR | | | |
|---|---|---|---|---|---|---|---|---|---|
| | | 23° C./50% RH | | 38° C./85% RH | | 23° C./50% RH | | Grease | |
| Sample | Calendered | cc/m²/d | | cc/m²/d | | g/m²/d | | resistance | |
| Example 1 | No | | | | | | | <15 | min |
| Example 2 | Yes | | | fail | 1654 | 453 | 447 | <15 | min |
| Example 3 | Yes | | | 52 | 60 | 2.1 | 2.0 | N.D. | |
| Example 4 | No | | | | | | | N.D. | |
| Example 5 | Yes | 0.9 | 1.1 | 41.0 | 48.0 | 23.2 | 24.5 | >48 | h |
| Example 6 | Yes | 0.2 | 0.7 | 54.6 | 56.0 | 12.5 | 15.2 | >56 | h |

The empty cells and N. D. means that the tests were not made since the sample had defects or did not pass the Gurley Hill tests, i.e. the G-H value was low.

While the invention has been illustrated by a description of various embodiments and examples while these embodiments and examples have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

1. A method for reducing the water vapour transmission rate (WVTR) of a cellulosic substrate comprising microfibrillated cellulose (MFC), said method comprising the steps of:
i. providing a cellulosic substrate comprising MFC;
ii. applying a first surface treatment composition to at least one surface of said cellulosic substrate, said first surface treatment composition comprising a water-soluble polymer and a crosslinker; and
iii. allowing said first surface treatment composition to cure to form a first barrier layer on said at least one surface of said cellulosic substrate.

2. The method according to claim 1, wherein said cellulosic substrate comprising MFC comprises at least 40% w/w MFC.

3. The method according to claim 1, wherein said crosslinker comprises an organic acid or organic polyacid, a metal salt of an organic acid or organic polyacid, or mixtures of an organic acid and a metal salt of an organic acid or organic polyacid.

4. The method according to claim 3, wherein the organic acid comprises citric acid, lactic acid, acetic acid, formic acid, oxalic acid, uric acid, malic acid, 1,2,3,4-butyltetracarboxylic acid, maleic acid, tartaric acid, or combinations thereof.

5. The method according to claim 3, wherein the first surface treatment composition is a buffered aqueous solution in which the crosslinker comprises an organic acid and a metal salt of said organic acid.

6. The method according to claim 1, wherein said water-soluble polymer comprises polyvinyl alcohol, polyacrylate, polysaccharides or mixtures or co-polymers thereof.

7. The method according to claim 1, wherein said substrate has an air resistance value according to ISO 5636-5 prior to application of said first surface treatment composition of less than 25,000 s/100 ml, and an air resistance value according to ISO 5636-5 after curing of said first surface treatment composition of greater than 25,000 s/100.

8. The method according to claim 1, wherein said substrate has a WVTR (at 23° C. and 500% RH) measured according to ASTM F-1249_prior to application of said first surface treatment composition of greater than 100 g/m²/d and a WVTR (at 23° C. and 50% RH) measured according to ASTM F-1249 after curing of said first surface treatment composition of less than 100 g/m²/d/.

9. The method according to claim 1, wherein the first surface treatment composition is applied in a coat weight of 1-10 gsm.

10. The method according to claim 1, further comprising the steps of:
after curing of said first surface treatment composition, applying a second surface treatment composition to said first barrier layer, said second surface treatment composition comprising a second water-soluble polymer; and
allowing said second surface treatment composition to dry and/or cure to form a second barrier layer.

11. The method according to claim 1, wherein the first surface treatment composition comprises at least 10% w/w water-soluble polymer.

12. The method according to claim 1, wherein steps ii. and iii. are repeated such that more than one first barrier layers are applied.

13. The method according to claim 1, wherein the first surface treatment composition has a pH between 3 and 7.

14. A barrier material comprising:
at least one layer of cellulosic substrate comprising MFC,
a first barrier layer arranged on at least one surface of said cellulosic substrate, said first barrier layer being formed by applying a first surface treatment composition comprising a water-soluble polymer and a crosslinker to said cellulosic substrate and allowing said first surface treatment composition to cure, thus forming the first barrier layer,
wherein said barrier material has a WVTR (at 23° C. and 50% RH) measured according to ASTM F-1249 of less than 100 g/m²/d.

15. The barrier material according to claim 14, wherein said cellulosic substrate comprising MFC comprises at least 40% w/w MFC.

16. The barrier material according to claim 14, wherein said crosslinker comprises an organic acid or organic polyacid, a metal salt of an organic acid or organic polyacid, or mixtures of an organic acid and a metal salt of an organic acid or organic polyacid.

17. The barrier material according to claim 14, wherein the first surface treatment composition is a buffered aqueous solution in which the crosslinker comprises an organic acid or organic polyacid, and a metal salt of said organic acid or organic polyacid.

18. The barrier material according to claim 14, wherein said water-soluble polymer comprises polyvinyl alcohol, polyacrylate, polysaccharides, or mixtures or co-polymers thereof.

19. The barrier material according to claim 14, further comprising:
a second barrier layer on said first barrier layer, said second barrier layer being formed by applying a second surface treatment composition comprising a second water-soluble polymer to said first barrier layer and allowing said second surface treatment composition to dry and/or cure.

20. The barrier material according to claim 14, wherein the second surface treatment composition is devoid of crosslinker.

21. The barrier material according to claim 14, further comprising more than one first barrier layers.
